(19) United States
(12) Patent Application Publication
(10) Pub. No.: US 2026/0233569 A1
(43) Pub. Date: Aug. 13, 2026

(54) METHOD FOR REDUCING OR AVOIDING KINETOSIS

(71) Applicant: MERCEDES-BENZ GROUP AG, Stuttgart (DE)

(72) Inventor: Dominique BOHRMANN, Plochingen (DE)

(21) Appl. No.: 19/155,729

(22) PCT Filed: Jan. 22, 2024
(86) PCT No.: PCT/EP2024/051455

§ 371 Date: Aug. 12, 2025

(30) Foreign Application Priority Data
Feb. 13, 2023 (DE) 10 2023 000 479.0

(51) Int. Cl. B60G 17/015; B60N 2/02

(52) U.S. Cl. CPC B60G 17/015; B60N 2/0224; B60G 2400/104; B60G 2400/824; B60G 2600/044; B60G 2800/24

(57) ABSTRACT

Kinetosis in an occupant during driving operation of a vehicle is reduced or prevented based on a determined course of a route lying ahead of the vehicle. A next transverse acceleration acting on the occupant is predicted using the determined course of the route ahead of the vehicle. To reduce or avoid kinetosis, a chassis and/or a vehicle seat of the vehicle occupied by the occupant is pivoted in the direction of the predicted transverse acceleration before the onset of the predicted transverse acceleration to prompt the occupant to perform a countermovement of the upper body or at least of the head.

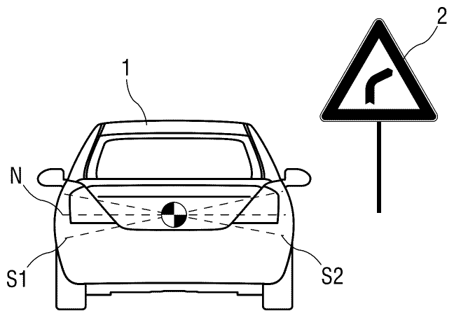

### BACKGROUND AND SUMMARY OF THE INVENTION

Exemplary embodiments of the invention relate to a method for reducing or avoiding kinetosis.

DE 10 2019 003 429 A1 describes a method for predicting and reducing kinetosis-related disturbances of an occupant during driving operation of a vehicle. The occupant is recorded at least by means of a vehicle camera. Depending on the stimuli acting on the occupant, the individual susceptibility of the occupant to kinetosis, and the type of activity performed during the driving operation, a metric is determined that indicates the probability of the onset of kinetosis-related disturbances. Depending on the determined metric, at least one individual measure from a catalogue of measures for preventing kinetosis-related disturbances is recommended to the occupant or automatically initiated.

Exemplary embodiments of the invention are directed to an improved method in comparison to the prior art for reducing or avoiding kinetosis.

In a method for reducing or preventing kinetosis in a passenger during driving operation of a vehicle, the course of a route ahead of the vehicle is determined, for example by means of a digital road map and a current position of the vehicle ascertained, for example, by means of a global navigation satellite system, and/or by means of a surroundings detection sensor system of the vehicle. The surroundings detection sensor system of the vehicle has as sensors, for example, at least one camera, for example a mono camera or stereo camera, and/or at least one radar sensor and/or at least one lidar sensor and/or at least one ultrasonic sensor. It can also have, for example, several identical or different sensors. By means of the surroundings detection sensor system, the course of the route ahead of the vehicle can be determined, for example, by detecting the route and/or route boundaries of the route and/or by detecting at least one traffic sign or information sign indicating the course of the route ahead of the vehicle. In addition to using, for example, the digital road map and the determined current position of the vehicle and/or using the surroundings detection sensor system of the vehicle, input information of the occupant can be used to determine the course of the route ahead of the vehicle, for example a destination that has been entered by the occupant, for example, into a navigation system of the vehicle, and/or a preferred route specified by the occupant and/or preferred route characteristics specified by the occupant.

According to the invention, the next lateral acceleration acting on the occupant and/or a resulting lateral force is predicted based on the determined course of the route ahead of the vehicle. This lateral acceleration acting on the occupant is, in particular, a centrifugal acceleration. It is caused in particular by a section of road formed as a curve, i.e., this lateral acceleration and the resulting lateral force, in particular in the form of a centrifugal force, will act on the occupant when driving through this section of road formed as a curve, in particular due to the inertia of the body of the occupant. Here, this lateral acceleration formed as centrifugal acceleration or this lateral force formed as centrifugal force is directed against a direction of the curve, i.e., when the section of the road of the route ahead of the vehicle for which the next lateral acceleration acting on the occupant is predicted is a right-hand bend, then the direction of this lateral acceleration or lateral force acting on the occupant is to the left, and when the section of the road of the route ahead of the vehicle for which the next lateral acceleration acting on the occupant is predicted is a left-hand bend, then the direction of this lateral acceleration or lateral force acting on the occupant is to the right.

The lateral force formed as a centrifugal force is the product of the lateral acceleration formed as a centrifugal acceleration and the mass of the occupant. The prediction of the lateral acceleration or lateral force is based in particular on the determined road ahead and a speed of the vehicle. The speed used for this purpose is, for example, a current speed and/or a speed of the vehicle predicted or predetermined for the road ahead, in particular for a road portion causing the next lateral acceleration. The predetermined speed is, for example, a maximum speed specified for this section of the route or a speed specified for automated, in particular highly automated or autonomous, driving operation of the vehicle for this section of the route. Alternatively or additionally, the speed and/or the magnitude of the lateral acceleration can be based, for example, on empirical values and/or learned values, and thus in particular on experience-based and personalized analyses, and can thus be predicted based on experience and/or learning. Here, the experience and/or the learned information are based, for example, on previously completed journeys, in particular with the same occupant, and/or on a driving style preferred by the occupant. For example, artificial intelligence is used to recognize the occupant and their preferred driving style. The prediction of the next lateral acceleration acting on the occupant can then be based, for example, on a link between a currently present situation and past, in particular learned, scenarios. As already mentioned above, the lateral acceleration is caused in particular by a section of the route that is formed as a curve, i.e., it will act on the occupant when driving through this section of the route formed as a curve.

As a measure to reduce or avoid kinetosis, a chassis and/or a vehicle seat occupied by an occupant is pivoted in the direction of the predicted lateral acceleration before the onset of the predicted lateral acceleration, in particular jerkily or abruptly, whereby the occupant is prompted to perform a countermovement of the upper body or at least the head. This means that this particularly jerky or abrupt pivoting movement is carried out in such a way that the occupant is prompted to perform the countermovement of the upper body or at least the head. The pivoting movement, in particular jerky or abrupt, is carried out with such force that this countermovement is thereby generated, i.e., is caused. The countermovement is then directed opposite to the direction of the predicted lateral acceleration. The occupant is thus prompted to actively lean their upper body or at least their head into the curve, also referred to as leaning or lying into the curve.

It is particularly provided that this pivoting of the chassis and/or the vehicle seat occupied by the occupant in the direction of the predicted lateral acceleration is carried out a few hundred milliseconds before the occurrence of the predicted lateral acceleration, in particular one second to 200 milliseconds before the occurrence of the predicted lateral acceleration.

In particular, it is provided that, as a further measure to reduce or avoid kinetosis, the chassis and/or the vehicle seat occupied by the occupant is then pivoted against the direction of the predicted lateral acceleration to support the countermovement of the occupant. Thus, the leaning of the upper body or at least the head of the occupant into the curve is supported by this pivoting of the chassis and/or the vehicle seat occupied by the occupant against the direction of the predicted lateral acceleration. This pivoting of the chassis and/or the vehicle seat occupied by the occupant against the direction of the predicted lateral acceleration is carried out, in particular, synchronously with the countermovement of the occupant. In order to ensure this, it can be provided, for example, that the countermovement of the occupant is determined, for example by means of a camera of the vehicle that records the occupant and in particular their movements and/or by means of an occupant movement sensor system, for example in the vehicle seat. Alternatively, for example, a waiting time is predetermined from the moment the chassis and/or the vehicle seat occupied by the occupant is pivoted in the direction of the predicted lateral acceleration until the moment the chassis and/or the vehicle seat occupied by the occupant is pivoted against the direction of the predicted lateral acceleration. In this case, the pivoting of the chassis and/or the vehicle seat occupied by the occupant against the direction of the predicted lateral acceleration is thus performed at the end of this waiting time, i.e., immediately after its expiration.

If the route portion of the section of the road ahead of the vehicle for which the next lateral acceleration acting on the occupant is predicted is a right-hand bend, then the direction of this lateral acceleration acting on the occupant, i.e., the centrifugal acceleration acting on the occupant, is to the left, in particular due to the inertia of the body of the occupant. The chassis and/or the vehicle seat occupied by the occupant is then pivoted in the direction of the predicted lateral acceleration and thus to the left, in particular jerkily or suddenly, before the onset of the predicted lateral acceleration, whereby the occupant is prompted to perform the countermovement of the upper body or at least the head. The countermovement thus runs to the right. The occupant thus actively inclines their upper body or at least their head into the bend, here the right-hand bend. As a further measure to reduce or prevent kinetosis, it is then provided, in particular, that the chassis and/or the vehicle seat occupied by the occupant is pivoted against the direction of the predicted lateral acceleration and thus to the right to support the occupant's countermovement. The tilting of the upper body, or at least the head of the occupant, into the curve is thus supported by this pivoting of the chassis and/or the vehicle seat occupied by the occupant. This pivoting of the chassis and/or the vehicle seat occupied by the occupant against the direction of the predicted lateral acceleration is carried out, in particular, synchronously with the countermovement of the occupant.

If the route portion of the section of the road ahead of the vehicle for which the next lateral acceleration acting on the occupant is predicted is a left-hand bend, then the direction of this lateral acceleration acting on the occupant, i.e., the centrifugal acceleration acting on the occupant, is to the right, in particular due to the inertia of the body of the occupant. The chassis and/or the vehicle seat occupied by the occupant is then pivoted in the direction of the predicted lateral acceleration and thus to the right, in particular jerkily or suddenly, before the onset of the predicted lateral acceleration, whereby the occupant is prompted to perform the countermovement of the upper body or at least the head. The countermovement thus runs to the left. The occupant thus actively inclines their upper body or at least their head into the bend, here the left-hand bend. As a further measure to reduce or prevent kinetosis, it is then provided, in particular, that the chassis and/or the vehicle seat occupied by the occupant is pivoted to the left to support the countermovement of the occupant, against the direction of the predicted lateral acceleration. The tilting of the upper body, or at least the head, of the occupant into the curve is thus supported by this pivoting of the chassis and/or the vehicle seat occupied by the occupant. This pivoting of the chassis and/or the vehicle seat occupied by the occupant, against the direction of the predicted lateral acceleration, is carried out, in particular, synchronously with the countermovement of the occupant.

The described pivoting of the chassis is carried out in particular by means of a chassis of the vehicle, in particular by a corresponding actuator of the vehicle. The described pivoting of the vehicle seat is carried out in particular by a corresponding pivot actuator, by means of which the vehicle seat is pivoted relative to the chassis in the described manner.

In the described method, which is carried out completely and in particular automatically by the vehicle or by at least one device of the vehicle, a driving dynamics predictive jerk control is carried out in the event of impending lateral dynamics in order to avoid kinetosis in the occupant of the vehicle.

Kinetosis, also known as motion sickness or travel sickness, is a natural physiological reaction of the human organism and is characterized by the cardinal symptoms of lethargy, sweating, headaches, and nausea. Fatigue, attention, and concentration problems can occur as subsequent effects and last for up to several hours or days. This can severely impact the ability to drive or take over control of the vehicle if automated, particularly highly automated or autonomous, operation of the vehicle is interrupted, and can pose a safety-critical problem.

Kinetosis occurs in particular when the human body detects sensory, in particular visual, vestibular, and somatosensory, movement stimuli, and these do not match past movement patterns stored in neuronal memory. A significantly higher prevalence of motion sickness is to be expected, in particular with increasing vehicle automation and the associated possibility for drivers to engage in secondary activities, particularly visually demanding ones, during automated, in particular highly automated or autonomous, driving.

By means of the method described, the postural stability of the occupant, in particular, is increased to reduce or prevent kinetosis, in particular when the occupant is unable to look ahead, i.e., in particular when a viewing direction of the occupant is not directed through the vehicle window into the external vehicle surroundings, for example, when reading. To this end, in the method described, in particular, as described above, a few hundred milliseconds before the onset of the predicted lateral acceleration, a rotary jerk is induced by the chassis and/or the vehicle seat in the manner described above, along the longitudinal axis of the vehicle or along a line parallel to the longitudinal axis of the vehicle, by the bodywork being pivoted in the manner described above by means of the chassis and/or pivoting the vehicle seat in the manner described above. A rolling movement of the chassis or at least the vehicle seat acting on the occupant is thus carried out. This induced movement follows the predicted and thus future occurring lateral acceleration, i.e., it is aligned in its direction, as described above. This thus induces a countermovement of the upper body or at least the head of the occupant. The jerk, i.e., the sudden or abrupt pivoting movement, is correspondingly executed with sufficient force in order to generate the countermovement. This reflexive countermovement is then advantageously supported by the chassis and/or the vehicle seat, i.e., by the described subsequent pivoting against the direction of the predicted lateral acceleration, which occurs in particular synchronously with the countermovement of the occupant.

In a possible embodiment of the method, it is provided that acoustic, visual, and/or tactile information output to the occupant is carried out as a further measure to reduce or prevent kinetosis. Here, in possible embodiment of the method, it is provided that the intensity of the information output is predetermined depending on the magnitude of the predicted lateral acceleration. Acoustic, visual, and tactile information can thus additionally serve to reduce or prevent kinetosis, in particular in order to clarify the information content of the future lateral movement and thus lateral acceleration to the occupant. Intensity-regulating information is of particular interest here. This means that greater lateral accelerations also produce louder acoustic signals and/or more intense colors or brightnesses. The intensity of the information output is thus predetermined depending on the magnitude of the predicted lateral acceleration, for example, by the volume of the acoustic information output and/or the color intensity and/or brightness of the visual information output being adjusted to the magnitude of the predicted lateral acceleration.

In a possible embodiment of the method, it is provided that the measure or the several measures to reduce or prevent kinetosis are/are only undertaken if the presence of at least one predetermined kinetosis criterion or several predetermined kinetosis criteria is determined. Here, kinetosis criteria are, in particular, criteria that indicate the presence of a kinetosis-critical situation, i.e., the presence of which poses or increases the risk of kinetosis occurring.

For example, the measure or the several measures to reduce or prevent kinetosis are only taken if:
the predicted lateral acceleration exceeds a predetermined lateral acceleration threshold, and/or
the occupant exhibits kinetosis susceptibility, and/or
a current driving duration exceeds a predetermined driving duration threshold, and/or
the occupant is performing a secondary activity independent of the driving operation of the vehicle, and/or
the viewing direction of the occupant is directed downwards and/or away from the vehicle windows of the vehicle and/or directed toward an object related to the secondary activity, and/or
an interior temperature of the vehicle exceeds a predetermined interior temperature threshold, and/or
occupant discomfort, i.e. a lack of well-being of the occupant, is detected.

In particular, it is provided that the measure or the several measures to reduce or prevent kinetosis is/are only implemented if the predicted lateral acceleration exceeds the predetermined lateral acceleration threshold and, in addition, the presence of at least one further predetermined kinetosis criterion or several further predetermined kinetosis criteria is ascertained, for example, that
the occupant has kinetosis susceptibility, and/or
the current driving time exceeds the predetermined driving time threshold, and/or
the occupant is performing the secondary activity independent of the driving operation of the vehicle, and/or
the viewing direction of the occupant is directed downwards and/or is turned away from the vehicle windows of the vehicle and/or is directed toward the object related to the secondary activity, and/or
the interior temperature of the vehicle exceeds the predetermined interior temperature threshold, and/or
the discomfort of the occupant, i.e., the lack of well-being of the occupant, is ascertained.

The kinetosis susceptibility of the occupant, i.e., how sensitive or susceptible the occupant is with regard to the occurrence of kinetosis, can be transmitted to the vehicle, for example, by information from the occupant, for example, by a speech input or a written input of this information by the occupant, or it can be determined, for example, by information from previous journeys of the occupant with the vehicle, which is determined and stored by the vehicle, in particular by means of occupant sensor system.

The current driving duration is determined, for example, by a journey time meter of the vehicle or in another way.

The secondary activity independent of the driving operation is, in particular, an activity that is not necessary for carrying out the driving operation and is not related to the driving operation. Such a secondary activity includes, for example, reading, for example reading a book or a newspaper, or playing games, for example playing computer games, or watching a video or television program. Whether the occupant is performing such a secondary activity can be determined, for example, by means of the occupant sensor system of the vehicle, in particular by means of a camera.

The viewing direction of the occupant can be ascertained, for example, by means of the occupant sensor system of the vehicle, in particular by means of a camera.

The interior temperature is determined, for example, by means of an interior temperature sensor of the vehicle.

The well-being and thus also the lack of well-being, i.e., the discomfort, of the occupant can be determined, for example, by means of the occupant sensor system of the vehicle, for example by means of the camera and/or by means of a sensor system for determining the vital parameters of the occupant.

If the occupant is a driver of the vehicle, the method is carried out for this occupant in particular or exclusively during automated, particularly highly automated or autonomous, driving operation of the vehicle. Here, the driver is the occupant of the vehicle who must assume control of the vehicle if this automated driving operation is interrupted, in particular must actively drive the vehicle.

If the occupant is not the driver of the vehicle, then the method can be carried out for this occupant during automated, in particular highly automated or autonomous, driving operation of the vehicle and/or in other driving situations, in particular also during driving operation of the vehicle actively carried out by a driver.

The described method can also be carried out for several occupants of the vehicle. In particular, when the respective pivoting movement is carried out by the vehicle seat of the respective occupant, the method can here be carried out individually for the respective occupant, in particular depending on the presence of the at least one or the respective kinetosis criterion with respect to the respective occupant. Here, in particular, the presence of kinetosis susceptibility, the performance of the secondary activity independent of driving, the viewing direction, and the state of well-being, i.e., the presence or absence of discomfort, can differ among the occupants, such that the method is then carried out, for example, only for one of the occupants or only for some of the several occupants.

Compared to existing technical solutions that aim to compensate for lateral dynamics, for example, by the vehicle being tilted into the bend while cornering and thus only when lateral acceleration occurs by means of tilting technology, the focus of the solution described here is to provide predictive impulses and thus induce the own movement of the occupant against the centrifugal force. Here, the activation of the human musculoskeletal system is important and not the passive guide of the person to compensate for the resulting lateral force. It has been shown that only active movements lead to a reduction in kinetosis. The solution described lies, in particular, in the provocation of reflexive body movements. The stimulation cannot thus be ignored without voluntary suppression, but instead leads to immediate muscle activity and here stimulates, among other things, the vestibulo-spinal reflex and/or the vestibulo-collic reflex and/or the cervico-collic reflex. This stimulation is particularly beneficial for reducing or preventing kinetosis.

Exemplary embodiments of the invention are explained below in more detail by means of the drawings.

### BRIEF DESCRIPTION OF THE SOLE DRAWING FIGURE

Here are shown in:

The sole drawing figure schematically illustrates an exemplary embodiment of a method for reducing or avoiding kinetosis in an occupant during driving operation of a vehicle.

### DETAILED DESCRIPTION

The sole drawing figure shows an exemplary traffic situation during driving operation of a vehicle 1 and a method carried out here for reducing or avoiding kinetosis in an occupant of this vehicle 1. A component or required input variable of the described technical solution is, in particular, a prediction of a future trajectory of the vehicle 1, i.e., in particular, a route ahead of the vehicle 1, and an associated description of a future lateral acceleration, in particular centrifugal acceleration, of the occupant of the vehicle 1.

In the method described below, it is provided, in particular, that if a predefined lateral acceleration threshold is exceeded and additional criteria for a kinetosis-critical situation are sensed, the measures described below to reduce or prevent kinetosis are carried out. Criteria relevant to kinetosis include, for example, the individual kinetosis susceptibility of the occupant, driving duration, a secondary activity of the occupant, the interior temperature of vehicle 1, and the current state of well-being of the occupant. Situations critical for kinetosis occur, for example, when the occupant looks downwards, for example, in order to read a book or pursue another secondary activity.

In the method described here for reducing or preventing kinetosis in an occupant during the driving operation of vehicle 1, the course of the route ahead of vehicle 1 is determined, for example, by means of a digital road map and a current position of vehicle 1 determined, for example, by means of a global navigation satellite system, and/or by means of a surroundings detection sensor system of vehicle 1. By means of the surroundings detection sensor system, the course of the route ahead of vehicle 1 can be determined, for example, by detecting the route and/or route boundaries of the route and/or by detecting at least one traffic sign 2 or information sign indicating the course of the route ahead of vehicle 1. In the example depicted, such a traffic sign 2 is present, which indicates a sharp right-hand bend ahead of vehicle 1.

By means of the determined course of the route ahead for vehicle 1 and, for example, additional, in particular experience-based, parameters of the driving dynamics, the next lateral acceleration acting on the occupant is predicted. This lateral acceleration acting on the occupant is, in particular with regard to its direction, the centrifugal acceleration that acts on the occupant, in particular due to the inertia of their body, while vehicle 1 negotiates the bend. The prediction of the lateral acceleration is based, in particular, on the determined route ahead and a speed of vehicle 1. The speed used for this purpose is, for example, a current speed and/or a speed of vehicle 1 predicted or predetermined for the route ahead, in particular for a section of road causing the next lateral acceleration. The predetermined speed is, for example, a maximum speed predetermined for this section of road or a speed predetermined for automated, in particular highly automated or autonomous, driving operation of vehicle 1 for this section of road. In the example depicted, this section of road is the right-hand bend. The speed of vehicle 1 is thus the speed predicted or predetermined for driving through this right-hand bend or is used to ascertain the speed predicted or specified for driving through this right-hand bend.

As a measure to reduce or prevent kinetosis, as depicted in the sole drawing figure, a chassis of the vehicle 1 or alternatively or additionally a vehicle seat of the vehicle 1 occupied by the occupant is pivoted in the direction of the predicted lateral acceleration before the onset of the predicted lateral acceleration, in particular jerkily or abruptly, whereby the occupant is prompted to carry out a countermovement of the upper body or at least the head. This pivoting is schematically illustrated in the sole drawing figure by a first pivot line S1, which illustrates an orientation of the chassis of the vehicle 1 pivoted relative to a normal position, i.e., in particular to a horizontal orientation, of the vehicle 1 around a vehicle longitudinal axis or around a line parallel to the vehicle longitudinal axis. Here, the normal position of the vehicle 1 is depicted by a normal position line N corresponding to an orientation of a vehicle transverse axis of the vehicle 1 in the normal position. The first pivot line S1 corresponds to an orientation of the vehicle transverse axis of vehicle 1 after pivoting the chassis in the direction of the predicted lateral acceleration.

The pivoting movement, particularly a jerky or sudden one, is here carried out with such force that this countermovement is generated, i.e., triggered. It is provided, in particular, that this pivoting of the chassis and/or the vehicle seat occupied by the occupant in the direction of the predicted lateral acceleration is carried out a few hundred milliseconds, for example, one second to 200 milliseconds, before the onset of the predicted lateral acceleration.

Furthermore, it is provided that as a further measure to reduce or avoid kinetosis in the example depicted, the chassis or alternatively or additionally the vehicle seat occupied by the occupant is pivoted against the direction of the predicted lateral acceleration to support the countermovement of the occupant. This pivoting is schematically illustrated in the sole drawing figure by a second pivot line S2, which illustrates an orientation of the chassis of vehicle 1 pivoted relative to the normal position around the vehicle longitudinal axis or around the line parallel to the vehicle longitudinal axis. The second pivot line S2 corresponds to an orientation of the vehicle transverse axis of vehicle 1 after the chassis has been pivoted against the direction of the predicted lateral acceleration. This pivoting of the chassis and/or the vehicle seat occupied by the occupant against the direction of the predicted lateral acceleration is carried out in particular synchronously with the countermovement of the occupant. For example, it compensates for at least the wheel load differences occurring due to lateral acceleration, including the associated deflection (rolling movement), such that the normal position of the vehicle 1, i.e., the normal position line N, is at least reached.

If the route portion of the section of the route ahead of vehicle 1 for which the next lateral acceleration acting on the occupant is predicted is a right-hand bend, as in the example according to the sole drawing figure, then the direction of this lateral acceleration acting on the occupant is to the left. The chassis and/or the vehicle seat occupied by the occupant of vehicle 1 is then pivoted in the direction of the predicted lateral acceleration and thus to the left, in particular jerkily or suddenly, before the onset of the predicted lateral acceleration, whereby the occupant is prompted to carry out the countermovement of the upper body or at least the head. The countermovement thus runs to the right, i.e., towards the inside of the bend. As a further measure to reduce or avoid kinetosis, it is then provided that the chassis and/or the vehicle seat occupied by the occupant is pivoted against the direction of the predicted lateral acceleration and thus to the right to support the countermovement of the occupant. This pivoting of the chassis and/or the vehicle seat occupied by the occupant against the direction of the predicted lateral acceleration is carried out synchronously with the countermovement of the occupant.

When the route portion of the route ahead of vehicle 1, for which the next lateral acceleration acting on the occupant is predicted, is a left-hand bend not depicted here, then the described movements, in particular pivoting movements, then take place in the opposite direction.

The described pivoting of the chassis is carried out in particular by means of a bodywork of the vehicle 1, in particular by a corresponding actuator of the vehicle 1. The described pivoting of the vehicle seat is carried out in particular by a corresponding pivoting actuator, by means of which the vehicle seat is pivoted relative to the chassis in the manner described.

Using the method described, in particular, the postural stability of the occupant is increased to reduce or prevent kinetosis, in particular when the occupant is unable to look ahead, i.e., in particular when the viewing direction of the occupant is not directed through the vehicle window into the external vehicle surroundings, for example, when reading. To this end, in the described method, in particular, as described above, a few hundred milliseconds before the onset of the predicted lateral acceleration, a rotary jerk is induced by the bodywork and/or the vehicle seat in the manner described above, along the vehicle longitudinal axis or along a line parallel to the vehicle longitudinal axis, by pivoting the chassis in the manner described above by means of the bodywork and/or pivoting the vehicle seat in the manner described above. This results in a rolling movement of the chassis or at least the vehicle seat acting on the occupant. This induced movement follows the predicted and thus future lateral acceleration, i.e., it is aligned in its direction, as described above. This thus induces a countermovement of the upper body or at least of the head of the occupant. The jerk is applied with sufficient force in order to generate the countermovement. This reflexive countermovement is then supported by the chassis and/or the vehicle seat, i.e., by the subsequent pivoting against the direction of the predicted lateral acceleration described above, which occurs synchronously with the countermovement of the occupant.

In particular, it is provided that, as a further measure to reduce or prevent kinetosis, acoustic, visual, and/or tactile information is output to the occupant. In a possible embodiment of the method, the intensity of the information output is here predetermined depending on the magnitude of the predicted lateral acceleration.

Acoustic, visual, and tactile information can thus additionally serve to reduce or prevent kinetosis, in particular in order to illustrate the information content of the future lateral movement and thus lateral acceleration to the occupant. Intensity-regulating information is of particular interest here. This means that greater lateral accelerations also trigger louder acoustic signals and/or more intense colors or brightnesses.

In particular, it is provided that the measures to reduce or prevent kinetosis will only be taken when the presence of predefined kinetosis criteria is determined. In particular, it is provided that the measures to reduce or prevent kinetosis are only taken when the predicted lateral acceleration exceeds the predetermined lateral acceleration threshold and, in addition, the presence of at least one further specified kinetosis criterion or several further predetermined kinetosis criteria is ascertained, for example, that
the occupant exhibits kinetosis susceptibility, and/or
the current driving time exceeds the predetermined driving time threshold, and/or
the occupant is performing the secondary activity independent of the driving operation of vehicle 1, and/or
the viewing direction of the occupant is directed downwards and/or is facing away from the vehicle windows of vehicle 1 and/or is directed towards the object related to the secondary activity, and/or
the interior temperature of vehicle 1 exceeds the predetermined interior temperature threshold, and/or
the discomfort of the occupant, i.e., the lack of well-being of the occupant, is determined.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
determining, by a vehicle, a route lying ahead of the vehicle;
predicting a next transverse acceleration acting on an occupant of the vehicle; and
pivoting a chassis or a vehicle seat of the vehicle occupied by the occupant, in a direction of the predicted next transverse acceleration before onset of the predicted next transverse acceleration so that the occupant of the vehicle is prompted to perform a countermovement of an upper body or a head of the occupant of the vehicle so as to reduce or avoid kinetosis of the occupant of the vehicle.

12. The method of claim 11, wherein the pivoting of the chassis or the vehicle seat occupied by the occupant in the direction of the predicted next lateral acceleration is performed a few hundred milliseconds before the onset of the predicted next acceleration.

13. The method of claim 11, further comprising:
pivoting the chassis or the vehicle seat occupied by the occupant against the direction of the predicted next lateral acceleration to support a countermovement of the occupant.

14. The method of claim 13, wherein the pivoting the chassis or the vehicle seat occupied by the occupant against the direction of the predicted next lateral acceleration is performed synchronously with the countermovement of the occupant.

15. The method of claim 14, further comprising:
determining the countermovement of the occupant of the vehicle.

16. The method of claim 11, further comprising:
outputting acoustic, visual, or tactile information to the occupant of the vehicle as a further measure to reduce or prevent kinetosis.

17. The method of claim 16, wherein an intensity of the outputted acoustic, visual, or tactile information is predetermined depending on a magnitude of the predicted next lateral acceleration.

18. The method of claim 11, further comprising:
determining presence of at least one predetermined kinetosis criterion,
wherein the pivoting a chassis or a vehicle seat of the vehicle occupied by the occupant is only performed when the presence of at least one predetermined kinetosis criterion is determined.

19. The method of claim 18, wherein the pivoting a chassis or a vehicle seat of the vehicle occupied by the occupant is only performed when the predicted next lateral acceleration exceeds a predetermined lateral acceleration threshold and the presence of at least one further specified kinetosis criterion is determined.

20. The method of claim 18, wherein the predetermined kinetosis criterion is one of:
the occupant of the vehicle exhibits a susceptibility to the kinetosis,
a current driving duration the vehicle exceeds a predetermined driving duration threshold,
the occupant of the vehicle is performing a secondary activity independent of operation of the vehicle,
a viewing direction of the occupant of the vehicle is directed downwards or away from windows of the vehicle or directed towards an object related to the secondary activity,
an interior temperature of the vehicle exceeds a predetermined interior temperature threshold, or
a discomfort of the occupant is determined.
